(19) United States
(12) Patent Application Publication
(10) Pub. No.: US 2023/0313597 A1
(43) Pub. Date: Oct. 5, 2023

(54) Transaction Window Assembly

(71) Applicant: Jay Kuerst, Prescott Valley, AZ (US)

(72) Inventor: Jay Kuerst, Prescott Valley, AZ (US)

(21) Appl. No.: 17/709,968

(22) Filed: Mar. 31, 2022

(51) Int. Cl. E05G 7/00

(52) U.S. Cl. CPC E05G 7/008

(57) ABSTRACT

A transaction window assembly includes a window frame that is positioned in an exterior wall of a building. A plurality of windows is each integrated into the window frame. A box is slidably disposed in respective ones of the plurality of windows. The box is positionable in an extended position to be accessible to the patron for accessing objects in the box. Conversely, the box is positionable in a retracted position to be accessible to the occupant of the building for placing the objects in the box. A card reader is attached to a respective one of the windows such that the card reader is accessible to the patron. A coin receiver is attached to a respective one of the windows such is accessible to the patron. A bill receiver is attached to a respective one of the windows such that the bill receiver is accessible to the patron.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to transaction devices and more particularly pertains to a new transaction device for facilitating a retail transaction between an occupant of a building and a patron without involving physical contact between the occupant and the patron. The device includes a window frame and a plurality of windows integrated into the window frame. The device includes a box that is slidably integrated into the windows and which can be retracted into the building and extended outwardly from the building to facilitate the exchange of items between the occupant and the patron. The device includes a card reader for processing a financial transaction card, a coin receiver for receiving coin currency and a bill receiver for receiving paper currency.

### (2) Description of Related Art Including Information Disclosed Under 37 CFR 1.97 and 1.98

The prior art relates to transaction devices including a protective window that has a cylinder rotatably integrated into the window which has an opening for facilitating the exchange of object between a teller at a bank and a patron. The prior art discloses a theft proof teller mechanism that includes a vertically oriented cylinder with an opening and which is mounted into a rotation platform for facilitating exchange of an object between a teller at a bank and a patron. The prior art discloses a bullet proof cashier window that includes a sound baffles to facilitate verbal communication between a cashier and a patron. The prior art discloses a variety of cylindrical housings that are positionable in a wall for facilitating the transfer of objects between a cashier and a patron. The prior art discloses a telecommunication system for facilitating communication between bank tellers and drive-in customers at a bank. The prior art discloses a bank teller's window that includes a recess that extends into an interior of a bank and a slidable partition to facilitate a patron to access the recess.

### BRIEF SUMMARY OF THE INVENTION

An embodiment of the disclosure meets the needs presented above by generally comprising a window frame that is positioned in an exterior wall of a building. A plurality of windows is each integrated into the window frame. A box is slidably disposed in respective ones of the plurality of windows. The box is positionable in an extended position to be accessible to the patron for accessing objects in the box. Conversely, the box is positionable in a retracted position to be accessible to the occupant of the building for placing the objects in the box. A card reader is attached to a respective one of the windows such that the card reader is accessible to the patron. A coin receiver is attached to a respective one of the windows such is accessible to the patron. A bill receiver is attached to a respective one of the windows such that the bill receiver is accessible to the patron.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a transaction window assembly according to an embodiment of the disclosure.

FIG. 2 is a back view of an embodiment of the disclosure.

FIG. 3 is a right side phantom view of an embodiment of the disclosure.

FIG. 4 is a front perspective view of an embodiment of the disclosure.

FIG. 5 is a perspective in-use view of an embodiment of the disclosure.

### DETAILED DESCRIPTION OF THE INVENTION

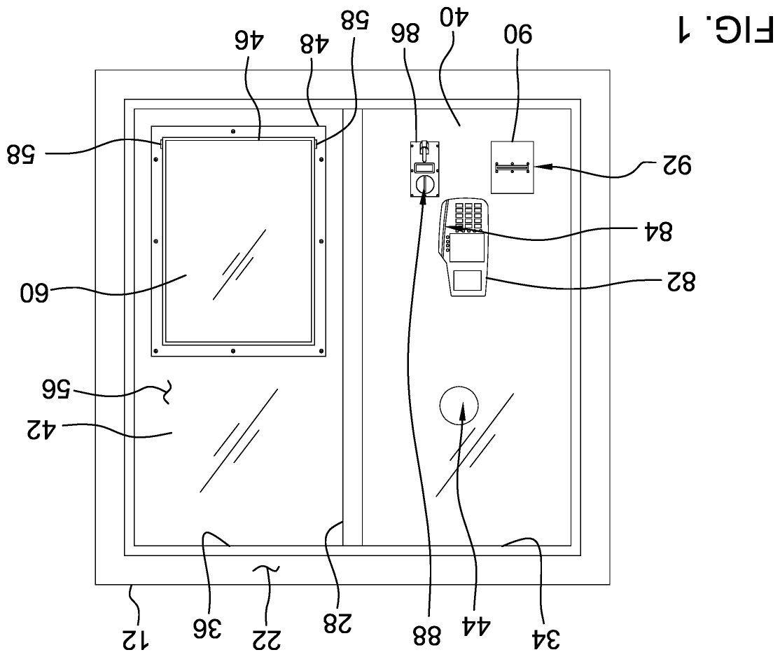

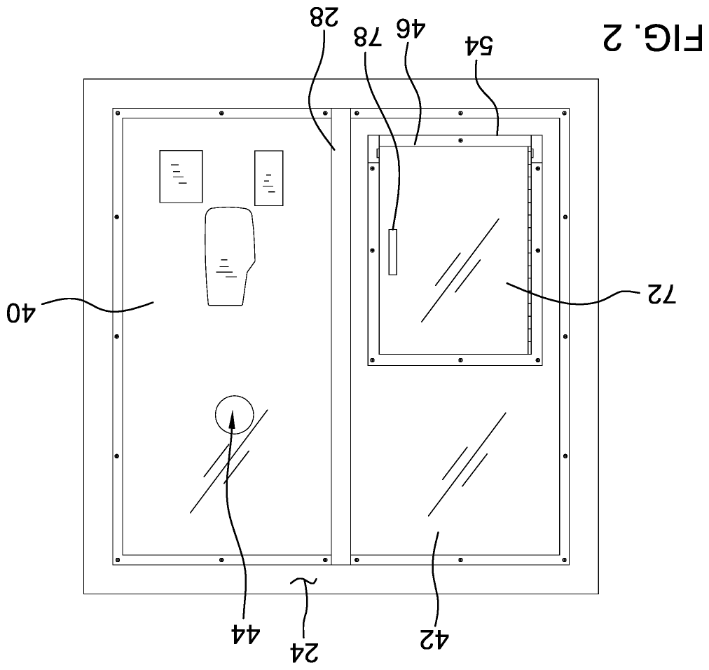

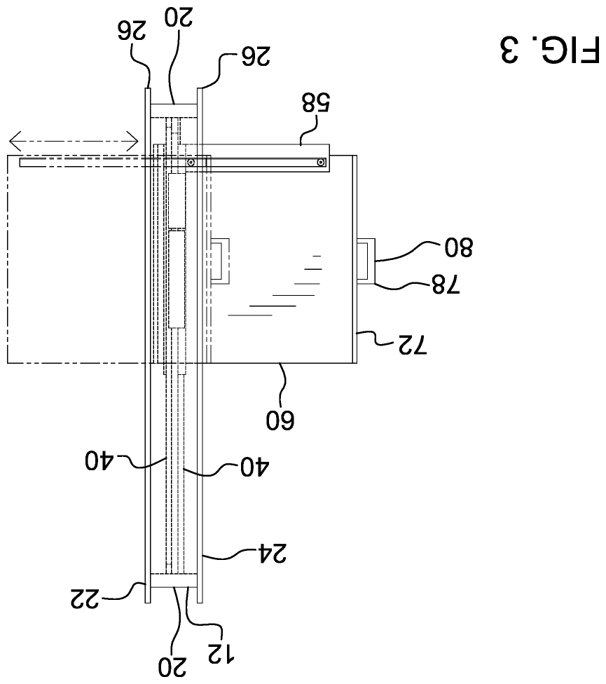

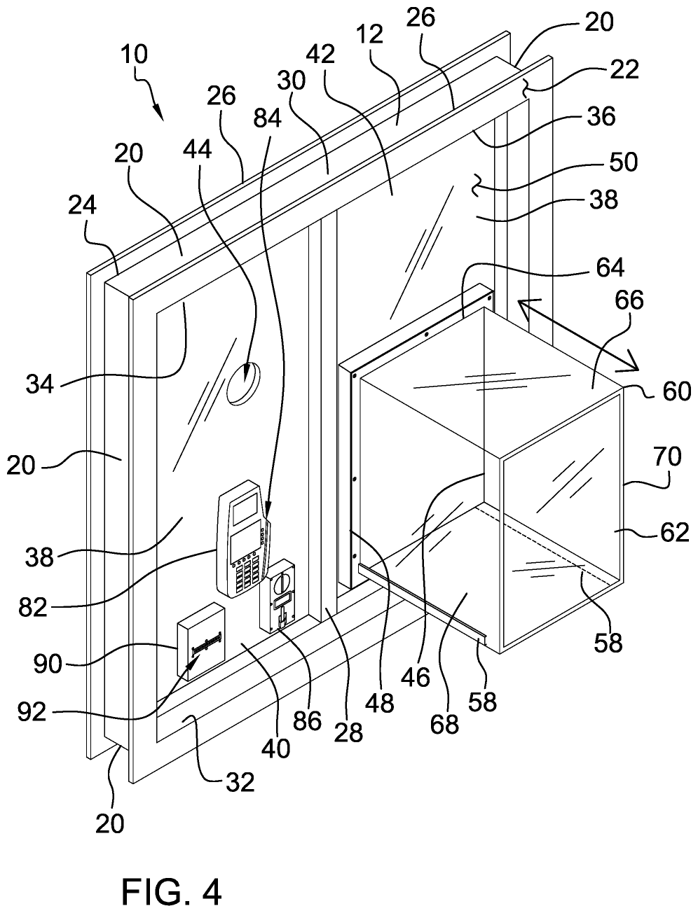

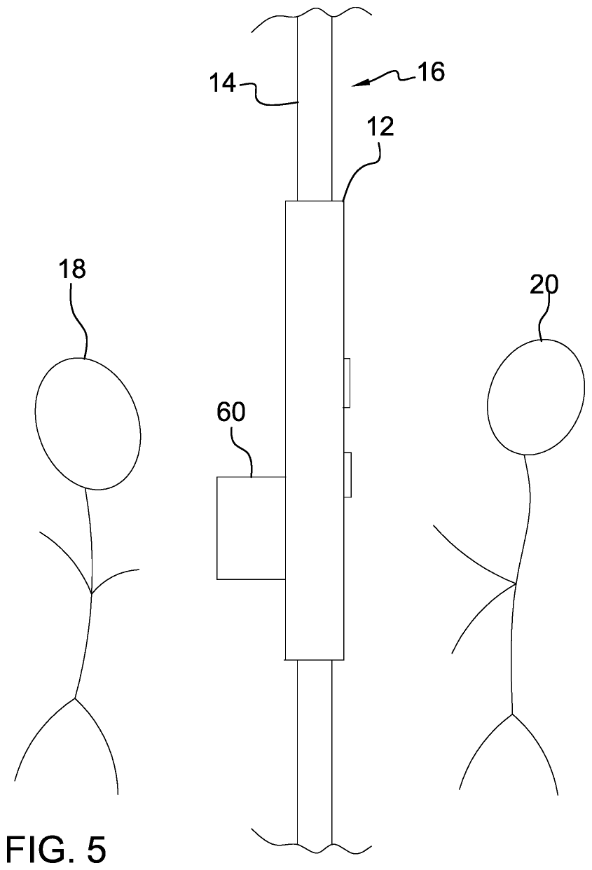

With reference now to the drawings, and in particular to FIGS. 1 through 5 thereof, a new transaction device embodying the principles and concepts of an embodiment of the disclosure and generally designated by the reference numeral 10 will be described.

As best illustrated in FIGS. 1 through 5, the transaction window assembly 10 generally comprises a window frame 12 that is positioned in an exterior wall 14 of a building 16. The building 16 may be a retail store or other building that involves financial transactions between an occupant 18 of the building 16 and a patron 19. The window frame 12 has a plurality of intersecting sides 20 such that the window frame 12 has a rectangular shape and each of the intersecting sides 20 has a forward surface 22 and a rearward surface 24. The window frame 12 has a pair of lips 26 each extending around each of the intersecting sides 20 and each of the lips 26 is aligned with a respective one of the forward surface 22 and the rearward surface 24 thereby facilitating the exterior wall 14 of the building 16 to be positioned between each of the lips 26. The window frame 12 has a member 28 extending between a top intersecting side 30 and a bottom intersecting side 32, and the member 28 is centrally positioned in the window frame 12 to define a first opening 34 and a second opening 36 in the window frame 12.

A plurality of windows 38 is provided and each of the windows 38 is integrated into the window frame 12. Each of the windows 38 is comprised of a projectile resistant material to protect the occupant 18 of the building 16 from a projectile such as a bullet fired from a firearm. The plurality of windows 38 includes a set of first windows 40 and a set of second windows 42. Each of the first windows 40 is positioned in the first opening 34 defined in the window frame 12 and each of the first windows 40 completely closes the first opening 34. Additionally, each of the second windows 42 is positioned in the second opening 36 defined in the window frame 12 and each of the second windows 42 completely closes the second opening 36. Each of the first windows 40 and each of the second windows 42 is spaced inwardly from a respective one of the forward surface 22 and the rearward surface 24 of the intersecting sides 20.

Each of the first windows 40 has a hole 44 extending therethrough and the hole 44 in each of the first windows 40 is aligned with each other to facilitate the occupant 18 of the building 16 to speak with the patron 19 standing outside of the building 16. Each of the second windows 42 has an opening 46 extending therethrough and the opening 46 in each of the second windows 42 is aligned with each other. A first box frame 48 is attached to a front surface 50 of a respective one of the second windows 42 and the first box frame 48 surrounds the opening 46 in the respective second window 42. A second box frame 54 is attached to a rear surface 56 of a respective one of the second windows 42 and the second box frame 54 surrounds the opening 46 in the respective second window 42.

A pair of tracks 58 is each slidably coupled to the first box frame 48 and the second box frame 54 such that each of the tracks 58 extends along a line that is oriented perpendicular to the front surface 50 and the rear surface 56 of the respective second windows 52. A box 60 is slidably disposed in respective ones of the plurality of windows 38 and the box 60 is positionable in an extended position having the box 60 extending outwardly from the building 16. In this way the box 60 is accessible to the patron 19 thereby facilitating the patron 19 to access objects in the box 60. Conversely, the box 60 is positionable in a retracted position having the box 60 extending into an interior of the building 16. In this way the box 60 is accessible to the occupant 18 of the building 16 thereby facilitating the occupant 18 to place the objects in the box 60. The box 60 has a front side 62, a back side 64 and an outer wall 66 extending between the front side 62 and the back side 64, and each of the front side 62 and the back side 64 is open. The outer wall 66 has a first lateral side 68 and a second lateral side 70, and each of the first lateral side 68 and the second lateral side 70 of the outer wall 66 is coupled to a respective one of the tracks 58.

A door 72 is hingedly coupled to the box 60 for opening 46 and closing the box 60 and the door 72 is positioned within the interior of the building 16 to be accessible to the occupant 18 of the building 16. The door 72 is comprised of a projectile resistant material to protect the occupant 18 of the building 16 from a projectile such as a bullet fired from a firearm. The door 72 has a first lateral edge 74 and a rear surface 76, and the first lateral edge 74 is hingedly coupled to the back side 64 of the box 60 corresponding to the first lateral side 68 of the outer wall 66 of the box 60. A handle 78 is attached to the rear surface 76 of the door 72 and the handle 78 has a member 80 that is spaced from the rear surface 76 for gripping.

A card reader 82 is attached to a respective one of the windows 38 such that the card reader 82 is positioned outside of the building 16 such that the card reader 82 is accessible to the patron 19. The card reader 82 has a card slot 84 integrated into the card reader 82 thereby facilitating a financial transaction card to be swiped through the card slot 84 for processing a purchase of retail goods. Additionally, the card reader 82 is positioned on the forward surface 22 of a respective one of the first windows 40 such that the card reader 82 is positioned outside of the building 16. The card reader 82 may be an electronic card reader of any conventional design which reads a magnetic strip on a credit card, for example, and the card reader 82 may include a chip reader for reading an electronic chip in a credit card, for example. Furthermore, the card reader 82 may be in communication with an extrinsic communication network, either through a wired connection or a wireless connection, to facilitate electronic credit card payments to be processed.

A coin receiver 86 is attached to a respective one of the windows 38 such that the coin receiver 86 is positioned outside of the building 16 to be accessible to the patron 19. The coin receiver 86 has a coil slot that is integrated into the coin receiver 86 thereby facilitating coin currency to be inserted into the coin slot 88 to facilitate purchasing retail goods. In this way the coin receiver 86 can receive payment of the retail goods without physical contact between the occupant 18 of the building 16 and the patron 19. The coin receiver 86 is positioned on the forward surface 22 of the respective first window 40 on which the card reader 82 is positioned. Additionally, the coin receiver 86 may be an electronic coin receiver of any conventional design and the coin receiver 86 may have a portal that extends through the sets of first windows 40 to facilitate the occupant 18 to retrieve coins deposited in the coin receiver 86.

A bill receiver 90 is attached to a respective one of the windows 38 such that the bill receiver 90 is positioned outside of the building 16 to be accessible to the patron 19. The bill receiver 90 has a bill slot 92 integrated into the bill receiver 90 thereby facilitating paper currency to be inserted into the bill slot 92 to facilitate purchasing retail goods. In this way the bill receiver 90 can receive payment of the retail goods without physical contact between the occupant 18 of the building 16 and the patron 19. The bill receiver 90 is positioned on the forward surface 22 of the respective first window 40 on which the coin receiver 86 is positioned. The bill receiver 90 may be an electronic bill receiver of any conventional design and the bill receiver 90 may have a portal that extends through the sets of first windows 40 to facilitate the occupant 18 to retrieve bills inserted into the bill receiver 90.

In use, the patron 19 approaches the window and the patron 19 speaks to the occupant 18 through the pair of hole 44s to purchase a retail item, for example, or to conduct any other financial transaction. The patron 19 employs the card reader 82, the coin receiver 86 or the bill receiver 90, depending on the method of payment, to complete the purchase of the retail items or the pay for a service. The occupant 18 opens the door 72 on the box 60, places the purchased retail items in the box 60, closes the door 72 and slides the box 60 into the extended position to facilitate the patron 19 the remove the retail items from the box 60. In this way the patron 19 and the occupant 18 can accomplish a retail transaction without being in physical contact with each other thereby inhibiting the transmission of infectious diseases between the occupant 18 and the patron 19. Furthermore, the occupant 18 is protected from a projectile, such as a bullet fired from a firearm, while the occupant 18 is conducting the transaction with the patron 19.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A transaction window assembly for facilitating projectile protection for a service worker during a drive through transaction, said assembly comprising:
a window frame being positioned in an exterior wall of a building, said window frame having a plurality of intersecting sides such that said window frame has a rectangular shape;
a plurality of windows, each of said windows being integrated into said window frame, each of said windows being comprised of a projectile resistant material wherein each of said windows is configured to protect an occupant of the building from a projectile such as a bullet fired from a firearm;
a box being slidably disposed in respective ones of said plurality of windows, said box being positionable in an extended position having said box extending outwardly from the building wherein said box is configured to be accessible to the patron thereby facilitating the patron to access objects in said box, said box being positionable in a retracted position having said box extending into an interior of the building wherein said box is configured to be accessible to the occupant of the building thereby facilitating the occupant to place the objects in said box;
a card reader being attached to a respective one of said windows such that said card reader is positioned outside of the building wherein said card reader is configured to be accessible to the patron;
a coin receiver being attached to a respective one of said windows such that said coin receiver is positioned outside of the building wherein said coin receiver is configured to be accessible to the patron; and
a bill receiver being attached to a respective one of said windows such that said bill receiver is positioned outside of the building wherein said bill receiver is configured to be accessible to the patron.

2. The assembly according to claim 1, wherein each of said intersecting sides has a forward surface and a rearward surface, said window frame having a pair of lips each extending around each of said intersecting sides, each of said lips being aligned with a respective one of said forward surface and said rearward surface thereby facilitating the exterior wall of the building to be positioned between each of said lips, said window frame having a member extending between a top intersecting side and a bottom intersecting side, said member being centrally positioned in said window frame to define a first opening and a second opening in said window frame.

3. The assembly according to claim 2, wherein said plurality of windows includes a set of first windows and a set of second windows, each of said first windows being positioned in said first opening defined in said window frame having each of said first windows completely closing said first opening, each of said second windows being positioned in said second opening defined in said window frame having each of said second windows completely closing said second opening, each of said first windows and each of said second windows being spaced inwardly from a respective one of said forward surface and said rearward surface of said intersecting sides.

4. The assembly according to claim 3, wherein each of said first windows has a hole extending therethrough, said hole in each of said first windows being aligned with each other wherein each of said holes is configured to facilitate the occupant of the building to speak with a patron standing outside of the building.

5. The assembly according to claim 3, wherein each of said second windows has an opening extending therethrough, said opening in each of said second windows being aligned with each other.

6. The assembly according to claim 5, further comprising:
a first box frame being attached to a front surface of a respective one of said second windows, said first box frame surrounding said opening in said respective second window; and
a second box frame being attached to a rear surface of a respective one of said second windows, said second box frame surrounding said opening in said respective second window.

7. The assembly according to claim 6, further comprising a pair of tracks, each of said tracks being slidably coupled to said first box frame and said second box frame such that each of said tracks extends along a line being oriented perpendicular to said front surface and said rear surface of said respective second windows.

8. The assembly according to claim 7, wherein said box has a front side, a back side and an outer wall extending between said front side and said back side, each of said front side and said back side being open, said outer wall having a first lateral side and a second lateral side, each of said first lateral side and said second lateral side of said outer wall being coupled to a respective one of said tracks.

9. The assembly according to claim 8, further comprising a door being hingedly coupled to said box for opening and closing said box, said door being positioned within the interior of the building wherein said door is configured to be accessible to the occupant of the building, said door being comprised of a projectile resistant material wherein said door is configured to protect the occupant of the building from a projectile such as a bullet fired from a firearm, said door having a first lateral edge and a rear surface, said first lateral edge being hingedly coupled to said back side of said box corresponding to said first lateral side of said outer wall of said box.

10. The assembly according to claim 3, wherein said card reader has a card slot integrated into said card reader thereby facilitating a financial transaction card to be swiped through said card slot for processing a purchase of retail goods, said card reader being positioned on said forward surface of a respective one of said first windows such that said card reader is positioned outside of the building.

11. The assembly according to claim 3, wherein said coin receiver has a coil slot integrated into said coin receiver thereby facilitating coin currency to be inserted into said coin slot to facilitate purchasing retail goods wherein said coin receiver is configured to receive payment of the retail goods without physical contact between the occupant of the building and the patron, said coin receiver being positioned on said forward surface of said respective first window on which said card reader is positioned.

12. The assembly according to claim 3, wherein said bill receiver has a bill slot integrated into said bill receiver thereby facilitating paper currency to be inserted into said bill slot to facilitate purchasing retail goods wherein said bill receiver is configured to receive payment of the retail goods without physical contact between the occupant of the building and the patron, said bill receiver being positioned on said forward surface of said respective first window on which said coin receiver is positioned.

13. A transaction window assembly for facilitating projectile protection for a service worker during a drive through transaction, said assembly comprising:
a window frame being positioned in an exterior wall of a building, said window frame having a plurality of intersecting sides such that said window frame has a rectangular shape, each of said intersecting sides having a forward surface and a rearward surface, said window frame having a pair of lips each extending around each of said intersecting sides, each of said lips being aligned with a respective one of said forward surface and said rearward surface thereby facilitating the exterior wall of the building to be positioned between each of said lips, said window frame having a member extending between a top intersecting side and a bottom intersecting side, said member being centrally positioned in said window frame to define a first opening and a second opening in said window frame;
a plurality of windows, each of said windows being integrated into said window frame, each of said windows being comprised of a projectile resistant material wherein each of said windows is configured to protect an occupant of the building from a projectile such as a bullet fired from a firearm, said plurality of windows including a set of first windows and a set of second windows, each of said first windows being positioned in said first opening defined in said window frame having each of said first windows completely closing said first opening, each of said second windows being positioned in said second opening defined in said window frame having each of said second windows completely closing said second opening, each of said first windows and each of said second windows being spaced inwardly from a respective one of said forward surface and said rearward surface of said intersecting sides, each of said first windows having a hole extending therethrough, said hole in each of said first windows being aligned with each other wherein each of said holes is configured to facilitate the occupant of the building to speak with a patron standing outside of the building, each of said second windows having an opening extending therethrough, said opening in each of said second windows being aligned with each other;
a first box frame being attached to a front surface of a respective one of said second windows, said first box frame surrounding said opening in said respective second window;
a second box frame being attached to a rear surface of a respective one of said second windows, said second box frame surrounding said opening in said respective second window;
a pair of tracks, each of said tracks being slidably coupled to said first box frame and said second box frame such that each of said tracks extends along a line being oriented perpendicular to said front surface and said rear surface of said respective second windows;
a box being slidably disposed in respective ones of said plurality of windows, said box being positionable in an extended position having said box extending outwardly from the building wherein said box is configured to be accessible to the patron thereby facilitating the patron to access objects in said box, said box being positionable in a retracted position having said box extending into an interior of the building wherein said box is configured to be accessible to the occupant of the building thereby facilitating the occupant to place the objects in said box, said box having a front side, a back side and an outer wall extending between said front side and said back side, each of said front side and said back side being open, said outer wall having a first lateral side and a second lateral side, each of said first lateral side and said second lateral side of said outer wall being coupled to a respective one of said tracks;
a door being hingedly coupled to said box for opening and closing said box, said door being positioned within the interior of the building wherein said door is configured to be accessible to the occupant of the building, said door being comprised of a projectile resistant material wherein said door is configured to protect the occupant of the building from a projectile such as a bullet fired from a firearm, said door having a first lateral edge and a rear surface, said first lateral edge being hingedly coupled to said back side of said box corresponding to said first lateral side of said outer wall of said box;
a card reader being attached to a respective one of said windows such that said card reader is positioned outside of the building wherein said card reader is configured to be accessible to the patron, said card reader having a card slot integrated into said card reader thereby facilitating a financial transaction card to be swiped through said card slot for processing a purchase of retail goods, said card reader being positioned on said forward surface of a respective one of said first windows such that said card reader is positioned outside of the building;
a coin receiver being attached to a respective one of said windows such that said coin receiver is positioned outside of the building wherein said coin receiver is configured to be accessible to the patron, said coin receiver having a coil slot integrated into said coin receiver thereby facilitating coin currency to be inserted into said coin slot to facilitate purchasing retail goods wherein said coin receiver is configured to receive payment of the retail goods without physical contact between the occupant of the building and the patron, said coin receiver being positioned on said forward surface of said respective first window on which said card reader is positioned; and
a bill receiver being attached to a respective one of said windows such that said bill receiver is positioned outside of the building wherein said bill receiver is configured to be accessible to the patron, said bill receiver having a bill slot integrated into said bill receiver thereby facilitating paper currency to be inserted into said bill slot to facilitate purchasing retail goods wherein said bill receiver is configured to receive payment of the retail goods without physical contact between the occupant of the building and the patron, said bill receiver being positioned on said forward surface of said respective first window on which said coin receiver is positioned.
